(19) United States
(12) Patent Application Publication
(10) Pub. No.: US 2006/0024495 A1
(43) Pub. Date: Feb. 2, 2006

(54) Self-adhesive air cushion film as protection for fresh paint finishes during vehicle assembly, and production process

(75) Inventors: Horst Romling, Hollenstedt (DE); Arne Barkley, Winseldorf (DE); Ralf Fuchs, Alsfeld (DE); Klaus-Peter Graf, Buttelborn (DE); Stefan Wagner, Neustadt (DE)

Correspondence Address: Norris, McLaughlin & Marcus P.A., 18th Floor, 875 Third Avenue, New York, NY, 10022, US

(73) Assignees: tesa Aktiengesellschaft, Hamburg (DE); Sealed Air Verpackungen GmbH, Alsfeld (DE)

(21) Appl. No.: 11/189,355

(22) Filed: Jul. 26, 2005

(30) Foreign Application Priority Data
Jul. 27, 2004 (DE) 10 2004 036 417.6

(51) Int. Cl. B32B 7/12; B32B 15/04; B29C 41/24

(52) U.S. Cl. 428/343; 264/165

(57) ABSTRACT

A self-adhesive air cushion film for temporary protection of fresh paint surfaces of vehicles such as automobiles and freshly painted vehicle parts, having a first carrier film on which a second, bubble-forming carrier film is present, the bubbles being filled in particular with air, a sheet of polyethylene being inseparably applied at least partially to the bubbles, and a self-adhesive layer being applied to the film.

The invention relates to a self-adhesive air cushion film as protection for fresh paint finishes during vehicle assembly, to processes for the production, and to possible uses thereof.

Self-adhesive air cushion films as packaging materials for sensitive products are a conventionality. One particularly preferred grade, which is distinguished by the longevity of the air cushions and also by a rear-face masking sheet for the air cushions, so that the carrier sheet does not remain without cushioning between the cushions, is known under the brand name AirCap® from the company Sealed Air.

This air cushion film is distinguished by the fact that a three-layer construction of the film from polyethylene/barrier layer/polyethylene prevents air emerging from the individual bubbles in the film.

Applying self-adhesive air cushion films to freshly painted bodies in vehicle manufacture, especially automobile manufacture, harbors the risk that, beneath the adhesive of the self-adhesive air cushion film, the paint finishes, which immediately after their drying have not yet attained their final state and which consequently are soft and possibly also are still giving off condensates in gaseous form from crosslinking, will undergo irreversible deformation and/or discoloration.

Self-adhesive sheets which are intended for adhering to freshly painted bodies and which in extreme cases are required to remain on the paint finish throughout the assembly of the vehicle and throughout the chain of transit ending with the dealer, who prepares the vehicle, possibly after some time in storage, for display and/or for transfer to the purchaser, and which are expected not to give rise to irreversible deformation or discoloration of the paint finish, are also a conventionality. One preferred embodiment is produced by tesa AG and sold under the brand name tesa® Bodyguard.

By way of example, a paint protection sheet may be noted which is based on polyethylene-vinyl acetate (EVA) and is described in DE 195 32 220 A1. This system attains good bonding values after just a short time and ensures a high degree of bonding security against unwanted and unprompted detachment in transit. Disadvantages perceived by the user include the strong peel increase, which can be lessened with a mixture of different EVA copolymers as described in DE 100 50 499 A1.

For practical purposes in vehicle assembly, however, self-adhesive protective sheets of this kind frequently afford too little protection against mechanical exposure and are frequently adhered below self-adhesive air cushion films, rigid shells or cushioned covers in order to prevent these systems acting on the fresh paint finish. This approach implies additional worksteps and hence costs in vehicle manufacture both during application and during removal of the assembly protection measures.

It is an object of the invention to combine an air cushion film and a paint protection sheet into one product and to do so in a cost-effective way by using a modification of the paint protection sheet as an integral constituent in the production of the air cushion film, as a rear-face masking sheet.

This object is achieved by means of a self-adhesive air cushion film as described in the main claim. The dependent claims provide particularly advantageous embodiments of the subject matter of the invention, and also particularly advantageous uses of and production processes for the air cushion film of the invention.

The invention accordingly provides a self-adhesive air cushion film for temporary protection of fresh paint surfaces of vehicles such as automobiles and freshly painted vehicle parts, having a first carrier film on which a second, bubble-forming carrier film is present, the bubbles being filled in particular with air, a sheet of polyethylene being inseparably applied at least partially to the bubbles, and a self-adhesive layer being applied to the film.

In one first advantageous embodiment of the invention there is an adhesion promoter layer between the sheet and the layer of adhesive.

Furthermore, preferably, the first carrier film, the second carrier film and/or the sheet may contain at least one light stabilizer in an amount of at least 0.15% by weight and/or titanium dioxide, preferably in an amount of 5% to 15% by weight.

In one advantageous embodiment the second carrier film features a three-layer construction comprising polyethylene sheet/barrier layer/polyethylene sheet.

The first carrier film may be composed of polyolefins such as polyethylene, polypropylene, their blends or copolymers. The first carrier film may also be designed as a foam layer. It is within the concept of the invention, furthermore, to configure the first carrier film as a polyethylene-coated paper carrier.

For the self-adhesive compound a variety of adhesives may be used without restricting the utility of the sheet.

It is applied to the sheet preferably at coatweights of between 3 and 35 g/m², preferably between 8 and 20 g/m². Application may take place from solution, in hexane or benzene, for example, or else from the melt.

In one further preferred embodiment the self-adhesive compound is composed of butyl rubber, the isoprene fraction in the butyl rubber being preferably up to 1.2 mol percent, more preferably up to 1.8 mol percent.

Butyl rubbers are copolymers of isobutene and isoprene which are prepared by cationic polymerization in solution. The isoprene fraction varies typically between 0.5 and 5 mol percent. The isoprene is normally incorporated in 1,4 addition, so that, in contrast to polyisobutylene homopolymer, this polymer has double bonds in the main chain. Accordingly it constitutes a link between a straight poly-cis-isoprene, or natural rubber, and a polyisobutylene homopolymer.

A further group of butyl rubbers is that of the starbranched types, where more intensive branching is achieved through comonomers such as divinylbenzene. More recently, butyl rubbers having lateral double bonds have also been disclosed (1,2 and/or 3,4 addition of the isoprene), and are suitable in accordance with the invention.

Manufacturers of such products are in particular the companies Bayer (Bayer Butyl) and Exxon (Exxon Butyl).

In order to obtain sufficient cohesion for an adhesive application, particularly at elevated temperatures, the molar mass advantageously at least of part of the polyisobutylenes used is relatively high, generally at least 200 000 g/mol (number-average Mn).

The butyl rubbers, similarly to polyisobutylenes of medium molecular weight, are indeed inherently tacky. Nevertheless, in order to optimize their properties, particularly the adhesion characteristics, the adhesive compound of the protective sheet of the invention can advantageously be blended with one or more additives. Possible such additives include tackifiers (tackifier resins which optimize pressure-sensitive adhesion qualities), plasticizers, organic or inorganic fillers, pigments, light stabilizers, including those in the form of UV-absorbing, sterically hindered amines (HALS), aging inhibitors in the form, for example, of lactones, primary and secondary antioxidants, or further elastomers. As an option, crosslinking agents and crosslinking promoters may be added to the self-adhesive compound. An exhaustive selection of crosslinking agents and crosslinking promoters are described in Ullmann's Encyclopedia of Industrial Chemistry (6th Edition, 2003), sections “Rubber, 4. Chemicals and additives” and “Manual for Rubber Industry”, Bayer AG (1995).

Examples of possible elastomers for modifying the self-adhesive compound include polyisobutylenes, polyolefin copolymers such as EPM or EPDM, polybutenes, hydrogenated block copolymers of styrene and dienes, or acrylate copolymers. These elastomers are used in proportions in the range from 0 to 20 parts by weight, preferably below 10 parts by weight per 100 parts by weight of butyl rubber.

Examples of suitable tackifiers include synthetic hydrocarbon resins (of C₅ or C₉ monomers, for example), natural resins, polyterpene resins based on α-, β-pinene or γ-limonene, rosin and rosin derivatives, and others, as listed in Ullmann's Encyclopedia of Industrial Chemistry (6th Edition, 2003), sections “Resins-Synthetic” and “Resins-Natural”. Use is made primarily of fully or partly hydrogenated resins, which are more stable toward aging. In the adhesive of the protective sheet of the invention it is preferred to use 0 to 50 parts by weight, in particular 0 to 20 parts by weight, of a tackifier, based on 100 parts by weight of base polymer.

Examples of suitable plasticizers for the self-adhesive compound include aliphatic, cycloaliphatic, and aromatic mineral oils, diesters or polyesters of phthalic, trimellitic or adipic acid, liquid rubbers (nitrile or polyisoprene rubbers, for example), liquid polymers (of isobutene or ethylene/propylene), acrylic esters, polyvinyl ethers, liquid resins and soft resins based on the raw materials of tackifier resins, lanolin and other waxes, or liquid silicones. Aging-stable plasticizers without an olefinic double bond are particularly suitable. It is preferred to use 0 to 40 parts by weight, in particular 0 to 10 parts by weight, of a plasticizer, based on 100 parts by weight of base polymer.

In a further advantageous embodiment the layer of adhesive is composed of a mixture of synthetic rubbers:
a) the layer of adhesive being composed of a polar component A and an apolar component B,
b) the polar component A being present in a fraction of 50% to 99% by weight and consisting of a copolymer or mixture of copolymers of ethylene and vinyl acetate whose vinyl acetate content is between 40% and 80% by weight, and
c) the apolar component B being present in a fraction of 1% to 50% by weight and consisting of one or a mixture of homopolymers or copolymers of α-olefins having 2 to 12 carbon atoms, these polymers being saturated in the main chain and being amorphous or having a low degree of crystallinity.

Alternatively the apolar component B may be present in a fraction of 1% to 50% by weight and may consist of copolymers of α-olefins having 2 to 12 carbon atoms and nonconjugated dienes.

Suitable products for the polar component of the adhesive include ethylene-vinyl acetate (EVAc) grades whose VAc fraction is between 40% and 80% by weight, preferably between 50% and 70% by weight. It is also possible to blend different EVAc grades. Compounds suitable for the apolar component include poly-α-olefins such as polyisobutylene (PIB), poly-1-butene (PB), ethylene-propylene copolymers (EPM), ethylene-propylene-diene terpolymers (EPDM), the diene being nonconjugated, poly-1-hexene, poly-1-octene, and other copolymers of ethylene and α-olefins having 4-12 carbon atoms that are amorphous or have a low degree of crystallinity. The apolar polymers as well can be blended in order to obtain optimum properties.

In one further advantageous embodiment the self-adhesive compound is composed of polyethylene-vinyl acetate at a vinyl acetate content of 40% to 80% by weight, in particular 70% by weight, and with a loss angle tan δ of 0.6 to 1.0, measured at a temperature of 60° C. and a frequency of 10⁻² Hz, and of 0.4 to 0.7, measured at a temperature of 60° C. and a frequency of 10 Hz, the target properties.

The self-adhesive compound may be applied to the sheet from solution or from the melt. The self-adhesive layers as elucidated in more detail above may with advantage be blended with one or more additives such as tackifiers, plasticizers, organic or inorganic fillers, pigments, light stabilizers, preferably in the form of UV-absorbing, sterically hindered amines (HALS), aging inhibitors, preferably in the form of lactones, primary and secondary antioxidants, crosslinking agents and/or crosslinking promoters.

With particular advantage the self-adhesive air cushion film of the invention may be produced by the following process:

Arriving from an extruder, the second carrier film is cast through a die onto a transfer roll. The transfer roll lays the second carrier film onto a thermoforming roll, containing bubble-shaped depressions and a vacuum zone.

As it traverses the vacuum zone of the thermoforming roll, the second carrier film is drawn into the depressions in the thermoforming roll and thus forms the air-filled bubbles. Immediately following departure from the vacuum section of the thermoforming roll, and likewise arriving from an extruder, the first carrier film is applied through a die onto a further transfer roll and is transferred from the transfer roll to the thermoformed second carrier film.

Finally, the sheet of polyethylene, provided with a self-adhesive layer, is applied in a laminating station, consisting of two rolls, to the bubbles in the second carrier film, a procedure which takes place with application of pressure, which flattens the air-filled bubbles at the tip but does not compress them, and with application of heat, with hot air at approximately 180° C. being passed through a hot-air nozzle into the nip formed by the sheet and the second carrier film as they are brought together, so that the sheet is inseparably welded to the tips of the bubbles.

In accordance with further versions of the production process, the processing properties of the self-adhesive air cushion film thus produced can be enhanced by passing it through a perforation station in which perforations are made in the air cushion film at a distance, for example, of 250 mm, so that the film can be drawn off by hand. As a further option, the self-adhesive air cushion film can be trimmed at the production edges, divided into narrower strips, and wound up to form rolls.

In this form in particular, the air cushion film of the invention can be employed directly in the vehicle manufacturer's assembly process without further tools or apparatus.

With particular advantage the air cushion film of the invention can be used as assembly and/or transit protection on freshly painted surfaces of automobiles or automobile parts and also in general for protecting sensitive paint, metal, wood, plastic or glass surfaces.

By means of the figures described below, the air cushion film of the invention is elucidated in more detail in a particularly advantageous version, as is also a process for production thereof, without any intention that the invention should be unnecessarily restricted as a result. In the drawing

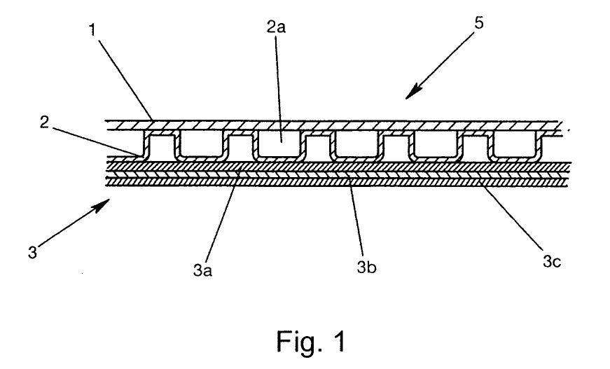

FIG. 1 shows the air cushion film of the invention and

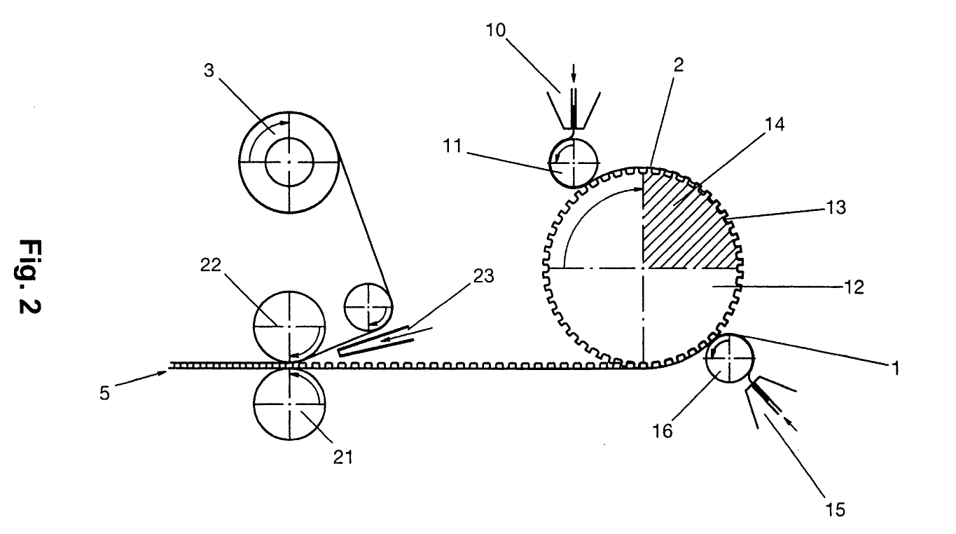

FIG. 2 shows a process for producing the air cushion film of the invention according to FIG. 1.

According to FIG. 1 the self-adhesive air cushion film 5 consists of a first carrier film 1, in this case a polyethylene sheet, on which there is a second carrier films, forming bubbles 2a, the bubbles 2a being air-filled.

Joined to the tips of the bubbles 2a is a multilayer sheet 3, a sheet of polyethylene 3a being applied inseparably to the tips of the bubbles 2a. The polyethylene sheet 3a is provided with a self-adhesive coating 3c, there being an adhesion promoter layer 3b present between sheet 3a and adhesive 3c.

FIG. 2 shows the production process of the air cushion film of the invention according to FIG. 1.

Arriving from an extruder, the second carrier film 2 is cast through a die 10 onto a transfer roll 11.

The transfer roll 11 lays the second carrier film 2 onto a thermoforming roll 12, containing bubble-shaped depressions 13 and a vacuum zone 14, which extends over a quarter of the thermoforming roll 12 (90°).

As it traverses the vacuum zone 14 of the thermoforming roll 12, the second carrier film 2 is drawn into the depressions 13 in the thermoforming roll 12 and thus forms the air-filled bubbles 2a.

Immediately following departure from the vacuum section 14 of the thermoforming roll 12, and likewise arriving from an extruder, the first carrier film 1 is applied through a die 15 onto a further transfer roll 16 and is transferred from the transfer roll to the thermoformed second carrier film 2.

Finally, the sheet 3 of polyethylene, provided with a self-adhesive layer, is applied in a laminating station, consisting of two rolls 21 and 22, to the bubbles 2a in the second carrier film 2, a procedure which takes place with application of pressure, which flattens the air-filled bubbles 2a at the tip but does not compress them, and with application of heat, with hot air at approximately 180° C. being passed through a hot-air nozzle 23 into the nip formed by the sheet 3 and the second carrier film 2 as they are brought together, so that the sheet 3 is inseparably welded to the tips of the bubbles 2a.

1. Self-adhesive air cushion film for temporary protection of fresh paint surfaces of vehicles and freshly painted vehicle parts, having a first carrier film on which a second, bubble-forming carrier film is present, the bubbles being filled with air, a sheet of polyethylene being inseparably applied at least partially to the bubbles, and a self-adhesive layer being applied to the film.

2. Self-adhesive air cushion film according to claim 1, having an adhesion promoter layer between the sheet and the layer of adhesive.

3. Self-adhesive air cushion film according to claim 1, wherein the first carrier film, the second carrier film and/or the sheet contain at least one light stabilizer in an amount of at least 0.15% by weight and/or titanium dioxide, in an amount of 5 to 15% by weight.

4. Self-adhesive air cushion film according to claim 1, wherein the second carrier film has a three-layer construction comprising polyethylene sheet/barrier layer/polyethylene sheet.

5. Self-adhesive air cushion film according to claim 1, wherein the first carrier film is composed of polyolefins selected from the group consisting of polyethylene, polypropylene and their blends or copolymers.

6. Self-adhesive air cushion film according to claim 1, wherein the self-adhesive compound is composed of butyl rubber, the isoprene content of the butyl rubber being up to 1.8 mol percent.

7. Self-adhesive air cushion film according to claim 1, wherein the self-adhesive layer blended with elastomers, polyolefin copolymers, polybutenes, hydrogenated block copolymers of styrene and dienes or acrylate copolymers, the elastomers being present in an amount ranging from 0 to 20 parts by weight.

8. Self-adhesive air cushion film according to claim 1, wherein the self-adhesive compound is composed of a polar component A and an apolar component B, the polar component A being present in an amount of 50% to 99% by weight and consisting of a copolymer or mixture of copolymers of ethylene and vinyl acetate whose vinyl acetate content is between 40% and 80% by weight, and the apolar component B being present in an amount of 1% to 50% by weight and consisting of one or a mixture of homopolymers or copolymers of α-olefins having 2 to 12 carbon atoms, these polymers being saturated in the main chain and being amorphous or having a low degree of crystallinity.

9. Self-adhesive air cushion film according to claim 1, wherein the self-adhesive compound is composed of a polar component A and an apolar component B, the polar component A being present in an amount of 50% to 99% by weight and consisting of a copolymer or mixture of copolymers of ethylene and vinyl acetate whose vinyl acetate content is between 40% and 80% by weight, and the apolar component B being present in a fraction of 1% to 50% by weight and consisting of copolymers of α-olefins of 2 to 12 carbon atoms and nonconjugated dienes.

10. Self-adhesive air cushion film according to claim 1, wherein the self-adhesive compound is composed of polyethylene-vinyl acetate having a vinyl acetate content of 40% to 80% by weight, and a loss angle tan δ of 0.6 to 1.0, measured at a temperature of 60° C. and a frequency of 10⁻² Hz, and of 0.4 to 0.7, measured at a temperature of 60° C. and a frequency of 10 Hz.

11. Self-adhesive air cushion film according to claim 1, wherein the self-adhesive layer is blended with one or more additives selected from the group consisting of tackifiers, plasticizers, organic or inorganic fillers, pigments, light stabilizers, aging inhibitors, primary and secondary antioxidants, crosslinking agents and crosslinking promoters.

12. Process for producing the self-adhesive air cushion film of claim 1, which comprises
receiving the second carrier film from an extruder and casting it through a die onto a transfer roll, which lays the second carrier film onto a thermoforming roll, containing bubble-shaped depressions and a vacuum zone,
drawing the second carrier film into the depressions in the thermoforming roll as it traverses the vacuum zone of the thermoforming roll thereby forming the bubbles,
immediately following departure of the second carrier film from the vacuum section of the thermoforming roll, applying a first carrier film from an extruder, through a die onto a further transfer roll and transferring said first carrier film from the further transfer roll to the thermoformed second carrier film,
applying a sheet of polyethylene, provided with a self-adhesive layer, in a laminating station, consisting of rolls, to the bubbles in the second carrier film, with application of pressure, which flattens the air-filled bubbles at the tip but does not compress them, and applying hot air at approximately 180° C. through a hot-air nozzle into the nip formed by the sheet of polyethylene and the second carrier film as the sheet of polyethylene is applied to the second carrier film, so that the sheet of Polyethylene is inseparably welded to the tips of the bubbles.

13. A method for protecting freshly painted surfaces of automobiles or automobile parts as during assembly and/or transit which comprises applying the self-adhesive air cushion film of claim 1 to said surfaces.

14. A method for protecting sensitive paint, metal, wood, plastic or glass surfaces which comprises applying the self-adhesive air cushion film of claim 1 to said surfaces.

15. Self-adhesive air cushion film according to claim 6, wherein the isoprene content of the butyl rubber is up to 1.2 mol percent.

16. Self-adhesive air cushion film according to claim 7, wherein said elastomers are polyisobutylenes, said polyolefin copolymers are EPM or EPDM, and the elastomers are present in amounts of less than 10 parts by weight per 100 parts by weight of butyl rubber.

17. Self-adhesive air cushion film according to claim 10, wherein said vinyl acetate content is 70% by weight.
